(19) United States
(12) Patent Application Publication
(10) Pub. No.: US 2007/0099001 A1
(43) Pub. Date: May 3, 2007

(54) Blister resistant optical coatings

(75) Inventor: John T. Melchior, San Diego, CA (US)

Correspondence Address: Matthew K. Hillman;Cymer, Inc., Legal Dept., MS/4-2C, 17075 Thornmint Court, San Diego, CA, 92127-2413, US

(73) Assignee: Cymer, Inc., San Diego, CA (US)

(21) Appl. No.: 11/260,929

(22) Filed: Oct. 27, 2005

(51) Int. Cl. B32B 15/04; B32B 19/00; B32B 9/00

(52) U.S. Cl. 428/446; 428/696; 428/701; 428/702; 428/450

(57) ABSTRACT

An optical coating and method for coating an optical element are disclosed. The optical element substrate may be made of fused silica and the coating may include a non-fluoride adherence layer such as SiO₂ that is deposited on the substrate to overlay and contact a surface of the substrate. The coating may further include a multilayer system having at least one layer of a dielectric fluoride material, the multilayer system overlaying the non-fluoride adherence layer.

### FIELD OF THE INVENTION

The present invention relates generally to reflective and anti-reflective optical coatings. The present invention is particularly, but not exclusively useful as a blister resistant optical coating for use on optical elements exposed to deep ultraviolet (DUV) laser light.

### BACKGROUND OF THE INVENTION

DUV radiation (i.e. radiation in the range of about 100 nm-300 nm) is either absorbed by or quickly degrades most “standard” optical materials. Thus, highly specialized materials are often required to construct optical components for use in the DUV spectrum, such as lenses, mirrors, windows, etalon plates etc. Moreover, within the DUV spectrum, materials which may be suitable for use at some light wavelengths, e.g. 248 nm corresponding to light emitted from a KrF excimer laser, may not be suitable for use at other wavelengths, e.g. 193 nm corresponding to light emitted from a ArF excimer laser. In addition to absorption, it is also generally necessary to control the surface reflectance of optical components used in DUV optical systems. For example, it may be desirable to reduce or eliminate reflections from one or more surfaces of lenses, windows, etalon plates, etc. On the other hand, mirrors and some surfaces of etalon plates and laser cavity output couplers may be designed to be fully or partially reflective.

Heretofore, one technique that has been used to produce DUV optical elements has involved coating a non-absorbing, non-degrading substrate with a multilayer system having a plurality of dielectric bi-layers. Typically, each bi-layer may include a layer of a first dielectric material and layer of a second dielectric material having a different index of refraction than the first dielectric material. In more detail, these multilayer dielectric coatings can be used to control the surface reflectivity of the optical element. For example, each plate for a flat-plate etalon designed for use with 193 nm light may include a fused silica substrate having one surface coated with a multilayer system having a stack of 1-5 bi-layers to produce an anti-reflecting surface and a second opposed surface coated with a multilayer system having a stack of 6-20 bi-layers to produce a highly reflecting surface.

In one such multi-layer scheme, each bi-layer may be made of one layer of Cryolite (Na₃AlF₆) and one layer of Gadolinium Fluoride GdF₃. Other fluorides may also be suitable for use at 193 nm. Each layer in the multilayer system is typically very thin, and may be, for example a fraction of a wavelength of the incident light, e.g. λ/4, λ/2, etc. where λ is a selected center wavelength of light illuminating the optic, e.g. 193 nm. The reflectivity of the coating is then dependent primarily on the number of layers, the refractive index and absorptance of each layer, and each layers thickness.

Unfortunately, multilayer fluoride systems like the one described above that are deposited directly on the substrate have a tendency to separate from the substrate when exposed to DUV light at low to moderate fluences. This separation causes blisters at the interface between the multilayer system and substrate which may be unacceptable for precision optical components. One particularly demanding application of the multi-layer technology described above is the design of a suitable metrology etalon for use in measuring center wavelength and/or bandwidth of 193 nm light, for example, from a laser light source.

To be an accurate metrology tool, the etalon must maintain its finesse. The finesse is determined by both the cavity geometry and reflectivity of the etalon. Both must remain high for high finesse. Any degradation in finesse will give a false reading. For example, if the etalon is used to measure bandwidth, a degradation in etalon finesse will erroneously indicate a bandwidth that is too large (i.e. cause false beam quality errors). An erroneous bandwidth, in turn, may indicate that a light source is out of specification and requires maintenance. Thus, unnecessary light source maintenance may result from degradation of a metrology etalon.

A high finesse etalon may also be used to measure center wavelength for use in a wavelength feedback loop, for example to control the output wavelength of a DUV light source. In order to maintain an accurate center wavelength calibration (often checked with an internal atomic wavelength reference (AWR) in a so-called wavemeter) the etalon cavity optical path length (ND number) must remain stable within specific calibration intervals (time between AWRs). For lithography applications, too high a drift in ND may cause undesirable focus shifts in a lithography stepper. It is thus desirable to maintain a very stable etalon cavity in terms of shape, reflectivity and dimension while it is being irradiated with DUV light.

For metrology etalons illuminated by 193 nm light, the requirements for low absorption and high throughput typically drive the use of fluorides for both high and low refractive index layers of the multi-layer coating. A unique etalon property is the multiple number of bounces the light trapped in the etalon cavity experience. This number increases with higher finesse (the reason finesse is important). So even small increases in absorption have a big influence on throughput. Oxides, which tend to be more stable than fluorides, generally cannot be used in large amounts since they will prevent high transmissions. They may also be susceptible to absorptive heating which can cause dimension changes.

One downside of the use of fluorides in the multilayer systems is that the fluoride materials tend to be porous and hydroscopic. In addition, the fluorides tend to be weak and have relatively high thermal expansion coefficients. Unlike some other coating materials, fluorides generally cannot be compacted with ion beams to stabilize them because this tends to increase their absorption. The movement of water in and out of fluoride coatings can change their properties drastically. Indeed, to be stable during use, the fluoride coatings must be dehydrated prior to use, otherwise, the coatings will dehydrate during use when exposed to DUV radiation such as 193 nm light.

For fluoride multilayer coatings that are deposited directly on the substrate, dehydration prior to use often results in crazing, delamination and/or blistering at the interface between the multilayer coating and the substrate. Thus, dehydration or exposure to DUV at low to moderate fluences can result in blistering at the interface. This blistering is most likely caused by a loss of adhesion between the multilayer coating and the substrate. In addition to loss of adhesion, dehydrating the coatings can also change their ND value and accordingly, may be tied to calibration accuracy (even if the etalon plates do not craze or blister). In short, for some applications, fluoride coatings that are capable of being dehydrated without damage prior to use may be required.

Several factors may contribute to the delamination and blistering at the interface between a fluoride multilayer system and substrate. For example, studies have shown that the higher the fluence or the more the pulses, the greater the damage, however, blistering was also observed at relatively low fluences. Another factor that may influence blistering at the interface is the proximity of the electric field peak of the light relative to the interface. Typically, the multilayer coating systems developed heretofore have placed the electric field peak of the light at or very near the interface. A difference in the coefficient of thermal expansion between the multilayer coating system and substrate can also effect adhesion. Also, when a fused silica substrate is used, exposing the substrate to DUV light may cause the fused silica substrate the develop a characteristic ridge and node compaction structure at very high fluences. The transition to this new structure near the interface may affect adhesion at the interface.

With the above considerations in mind, Applicants disclose a blister resistant optical coating and methods for coating an optical element for use on optical components exposed to deep ultraviolet (DUV) laser light, such as light having a wavelength of 193 nm.

### SUMMARY OF THE INVENTION

A coating for an optical element substrate is disclosed. The substrate may be made of fused silica and the coating may include a non-fluoride adherence layer that is deposited on the substrate to overlay and contact a surface of the substrate. The coating may further include a multilayer system having at least one layer of a dielectric fluoride material, the multilayer system overlaying the non-fluoride adherence layer.

In one embodiment, the non-fluoride layer may include an oxide such as SiO₂ or Al₂O₃. The multilayer system may include a plurality of bi-layers with each bi-layer comprising a layer of a first dielectric material having an index of refraction, n₁, and a layer of a second dielectric material having an index of refraction, n₂, with n₁≠n₂. For example, the first dielectric material may be Na₃AlF₆ and the second dielectric material may be GdF₃. In some implementations, the coating may be a reflective coating and may have between 6 and 20 bi-layers. In other implementations, the coating may be an anti-reflective coating and may have between 1 and 5 bi-layers.

In particular applications, an optic for interaction with light having a wavelength between 20-300 nm may be prepared. In one such application, the light has a wavelength, λ, centered at approximately 193 nm. For these applications, the non-fluoride layer may have a thickness of approximately λ/4, where λ is a selected center wavelength for light illuminating the optic, e.g. 193 nm. In one embodiment, the non-fluoride layer may have a thickness selected to distance an electric field peak of the light from an interface between the non-fluoride layer and the substrate.

In another aspect, an optic may include an optical element substrate made of a first material and a layer made of the first material that is deposited on the substrate to overlay and contact a surface of the substrate. The optic may also include a multilayer system having at least one layer of a dielectric fluoride material, with the multilayer system overlaying the non-fluoride layer. In one embodiment, the first material is selected to be substantially non-absorptive of light having a selected center wavelength, e.g. the first material may be SiO₂ for a center wavelength of 193 nm.

### BRIEF DESCRIPTION OF THE DRAWINGS

FIG. 1 shows a sectional view through an etalon assembly illustrating the etalon surfaces that are typically coated with reflective coatings and the surfaces that are typically coated with anti-reflective coatings;

FIG. 2 is an enlarged sectional view of an etalon plate illustrating an anti-reflective coating; and

FIG. 3 is an enlarged sectional view of a multilayer system.

### DETAILED DESCRIPTION OF PREFERRED EMBODIMENTS

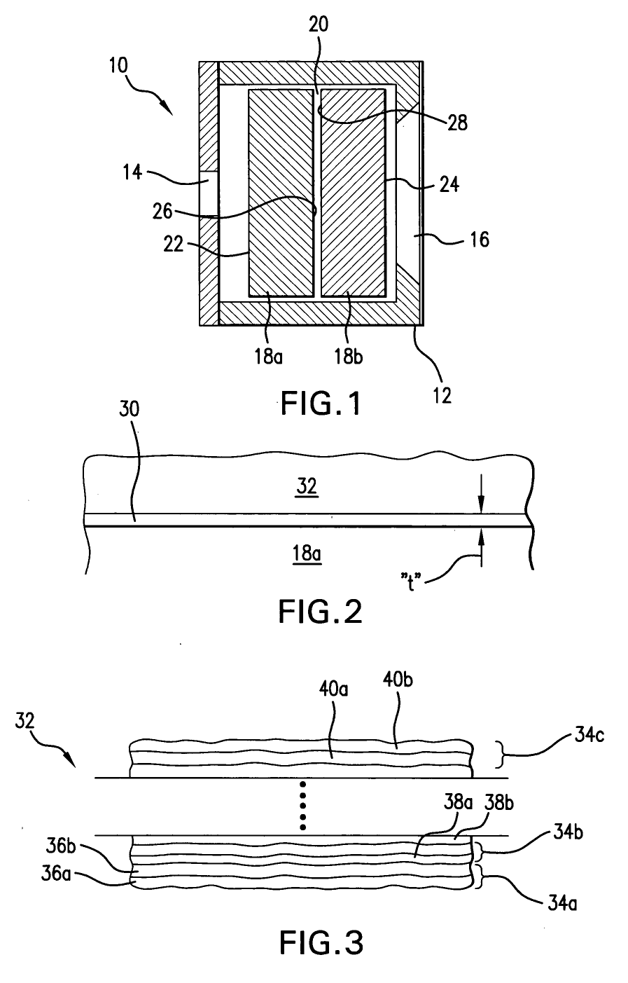

Referring initially to FIG. 1, an etalon assembly is shown and generally designated assembly 10. As shown, the assembly 10 may include an etalon housing 12 having an optical input window 14 and exit window 16. Two flat etalon plates 18a,b may be spaced apart and rigidly mounted, e.g. bonded using RTV adhesive, to the housing 12 to create an etalon cavity 18 between the plates. For the etalon assembly 10, surface 22 of plate 18a and surface 24 of plate 18b are typically coated with an anti-reflection coating and surface 26 of plate 18a and surface 28 of plate 18b are typically coated with a highly reflective coating.

FIG. 2 illustrates a coating for an optical element substrate, such as an etalon plate 18a. For use with 193 nm light, the substrate may be made of fused silica and the coating may include a coating layer 30 which may be an adherence layer that is deposited on the substrate to overlay and contact a surface of the substrate, as shown. FIG. 2 shows that the coating may further include a multilayer system 32 overlaying the coating layer 30.

In one embodiment, the layer 30 may include an oxide such as SiO₂ or Al₂O₃, having a relatively low absorption at the selected center wavelength. As shown, the layer 30 may be deposited to a thickness “t” which may be approximately λ/4, (and in some cases λ/2) where λ is a selected center wavelength for light illuminating the optic, e.g. 193 nm. The layer 30 may be deposited using any suitable deposition techniques known in the pertinent art such as, but not limited to, physical vapor deposition by thermal source or electron beam, or ion assisted deposition. Typically, the surface flatness of the substrate is tightly controlled and is tested before and after coating, for example, using a non-contact phase interferometer. Prior to deposition of the layer 30, the substrate may be cleaned using one or more of the following techniques such as ultrasonic aqueous cleaning and/or solvent cleaning, for example using high purity Methanol or some other suitable solvent.

FIG. 3 illustrates in greater detail a multilayer system 32 that may be deposited on layer 30 shown in FIG. 2. As shown there, the multilayer system 32 may include plurality of bi-layers 34a, 34b, 34c. For the multilayer system 32, each bi-layer may include a layer of a first dielectric material having an index of refraction, n₁, and a layer of a second dielectric material having an index of refraction, n₂, with n₁≠n₂ For example, for the system 32 shown, the bi-layer 34a may have a layer 36a of Na₃AlF₆ (Cryolite) and a layer 36b of GdF₃ (Gadolinium fluoride), the bi-layer 34b may have a layer 38a of Na₃AlF₆ and a layer 38b of GdF₃, and the bi-layer 34c may have a layer 40a of Na₃AlF₆ and a layer 40b of GdF₃. In some designs, each layer of the multilayer system 32 may have a layer thickness which may be approximately λ/4, (and in some cases λ/2) where λ is a selected center wavelength for light illuminating the optic, e.g. 193 nm. Each layer of the multilayer system 32 may be deposited using one of the techniques described above.

As indicated above, the use of fluorides in the multilayer system 32 may be advantageous due to their relatively low absorption at selected DUV wavelengths, such as 193 nm. Other suitable fluorides for use in the multilayer system may include, but are not necessarily limited to: Aluminum fluoride (AlF₃), Barium fluoride (BaF₂), Calcium fluoride (CaF₂), Dysprosium fluoride (DyF₃), Lanthanum fluoride (LaF₃), Magnesium fluoride (MgF₂), Neodymium fluoride (NdF₃), Terbium fluoride (TbF₃), Ytterbium fluoride (YbF₃), Yttrium fluoride (YF₃).

In some implementations, the multilayer system 32 may be configured for use in a reflective coating and may have between 6 and 20 bi-layers. In other implementations, the multilayer system 32 may be configured for use in an anti-reflective coating and may have between 1 and 5 bi-layers. In one arrangement for use as a reflective coating with 193 nm light, a fused silica substrate is coated with SiO₂ to a thickness “t” of approximately λ/4, and a multilayer system is used having 11-13 bi-layers of Na₃AlF₆ (Cryolite)/GdF₃ (Gadolinium fluoride) with each layer in the multilayer system having a thickness of approximately λ/4. In one arrangement for use as an anti-reflective coating with 193 nm light, a fused silica substrate is coated with SiO₂ to a thickness “t” of approximately λ/4, and a multilayer system is used having 2 bi-layers of Na₃AlF₆ (Cryolite)/GdF₃ (Gadolinium fluoride) with each layer in the multilayer system having a thickness of approximately λ/4. For each of these arrangements, the electric field peak of the light is distanced from the interface between the fused silica substrate and the deposited SiO₂ layer.

While the particular aspects of embodiment(s) described and illustrated in this patent application in the detail required to satisfy 35 U.S.C. §112 is fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present invention is solely and completely limited by only the appended claims and nothing beyond the recitations of the appended claims. Reference to an element in such claims in the singular is not intended to mean nor shall it mean in interpreting such claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present claims. Any term used in the specification and/or in the claims and expressly given a meaning in the Specification and/or claims in the present application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this application, for it to be encompassed by the present claims. No element, component, or method step in the present disclosure is intended to be dedicated to the public regardless of whether the element, component, or method step is explicitly recited in the claims. No claim element in the appended claims is to be construed under the provisions of 35 U.S.C. §112, sixth paragraph, unless the element is expressly recited using the phrase “means for” or, in the case of a method claim, the element is recited as a “step” instead of an “act”.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended claims are intended in scope and meaning to cover not only the disclosed aspects of embodiments of the present invention(s) but also such equivalents and other modifications and changes that would be apparent to those skilled in the art.

What is claimed is:

1. A coating for an optical element substrate made of fused silica, said coating comprising:
a non-fluoride adherence layer deposited on said substrate to overlay and contact a surface of said substrate; and
a multilayer system having at least one layer of a dielectric fluoride material, said multilayer system overlaying said non-fluoride adherence layer.

2. A coating as recited in claim 1 wherein said non-fluoride layer comprises an oxide.

3. A coating as recited in claim 1 wherein said oxide is SiO₂.

4. A coating as recited in claim 1 wherein said oxide is Al₂O₃.

5. A coating as recited in claim 1 wherein said coating is a reflective coating.

6. A coating as recited in claim 1 wherein said coating is an anti-reflective coating.

7. A coating as recited in claim 1 wherein said dielectric fluoride material is GdF₃.

8. A coating as recited in claim 1 wherein said dielectric fluoride material is Na₃AlF₆.

9. A coating as recited in claim 1 wherein said optical element is an etalon plate.

10. A coating as recited in claim 1 wherein said multilayer system comprises a plurality of bi-layers with each bi-layer comprising a layer of a first dielectric material having an index of refraction, n₁, and a layer of a second dielectric material having an index of refraction, n₂, with n₁≠n₂.

11. A coating as recited in claim 10 wherein said multilayer system comprises between 6 and 20 bi-layers.

12. A coating as recited in claim 10 wherein said multilayer system comprises between 1 and 5 bi-layers.

13. An optic for interaction with light having a wavelength between 20-300 nm, said optic comprising:
an optical element substrate made of fused silica;
a non-fluoride layer deposited on said substrate to overlay and contact a surface of said substrate; and
a multilayer system having at least one layer of a dielectric fluoride material, said multilayer system overlaying said non-fluoride layer.

14. An optic as recited in claim 13 wherein said light has a wavelength, λ, centered at approximately 193 nm.

15. An optic as recited in claim 14 wherein said non-fluoride layer has a thickness of approximately λ/4.

16. An optic as recited in claim 14 wherein said non-fluoride layer has a thickness selected to distance an electric field peak of said light from an interface between said non-fluoride layer and said substrate.

17. An optic comprising:
an optical element substrate made of a first material;
a layer made of said first material deposited on said substrate to overlay and contact a surface of said substrate; and
a multilayer system having at least one layer of a dielectric fluoride material, said multilayer system overlaying said non-fluoride layer.

18. An optic as recited in claim 17 wherein said first material is SiO₂.

19. An optic as recited in claim 17 wherein said multilayer system comprises a plurality of bi-layers with each bi-layer comprising a layer Na₃AlF₆ and a layer of GdF₃.

20. An optic as recited in claim 17 wherein said first material is substantially non-absorptive of light having a wavelength of 193 nm.
